(19) United States
(12) Patent Application Publication
(10) Pub. No.: US 2026/0140085 A1
(43) Pub. Date: May 21, 2026

(54) RRAM-BASED BLOOD TEST SYSTEM AND METHOD

(71) Applicant: INSTITUTE OF MICROELECTRONICS, CHINESE ACADEMY OF SCIENCES, Beijing (CN)

(72) Inventors: Feng ZHANG, Beijing (CN); Xiaofan Sun, Beijing (CN); Wenchang Zhang, Beijing (CN); Yao Li, Beijing (CN); Qirui Ren, Beijing (CN)

(73) Assignee: INSTITUTE OF MICROELECTRONICS, CHINESE ACADEMY OF SCIENCES, Beijing (CN)

(21) Appl. No.: 19/449,084

(22) Filed: Jan. 14, 2026

Related U.S. Application Data
(63) Continuation of application No. PCT/CN2024/103000, filed on Jul. 1, 2024.

(30) Foreign Application Priority Data
Mar. 29, 2024 (CN) 202410384193.9

(51) Int. Cl. G01N 27/414

(52) U.S. Cl. CPC G01N 27/4148; G01N 27/4145

(57) ABSTRACT

Provided are a resistive random-access memory (RRAM)-based blood test system and method. The system comprises: a computing chip, an RRAM chip, a power supply module, and a sensor module; the computing chip is connected to the RRAM chip; the RRAM chip is connected to the sensor module; and the power supply module is connected to the computing chip and the RRAM chip; the sensor module is configured to test a substance in blood and convert test result data into a plurality of pieces of first voltage data; the RRAM chip is configured to preprocess the received plurality of pieces of first voltage data and obtain second current data; and the computing chip is configured to, based on the second current data, perform a function computation on the second current data according to a preset function computation model, and obtain a blood-based classification result.

### CROSS REFERENCE TO RELATED APPLICATION

The present disclosure claims priority to Chinese Patent Application 202410384193.9, filed with the China National Intellectual Property Administration (CNIPA) on Mar. 29, 2024, and entitled “RRAM-based blood test system and method”, which is incorporated herein by reference in its entirety.

### TECHNICAL FIELD

The present disclosure relates to the technical field of integrated circuit design, and in particular to a resistive random-access memory (RRAM)-based blood test system and method.

### BACKGROUND

At present, disease screening via blood or urine tests has become a common practice in hospitals. However, blood-based screening methods exhibit significant limitations in both clinical and research settings. For example, comprehensive disease screening often requires drawing multiple tubes of blood from a single patient to test for various proteins or enzymes. The medical analysis equipment used is typically bulky and non-portable, restricting testing to fixed locations. Moreover, after data acquisition, the data must be uploaded to the cloud and processed by a personal computer (PC) to obtain results. Evidently, the entire testing process from blood collection to report generation is time-consuming, with samples remaining in storage tubes for extended periods. Additionally, the analysis results often fail to indicate the specific category of the disease. As a result, blood-based disease screening suffers from low efficiency and poor accuracy, falling short of user expectations.

### SUMMARY

An objective of the present disclosure is to provide a resistive random-access memory (RRAM)-based blood test system and method. The present disclosure solves the problems existing in the prior art. That is, the entire testing process from blood collection to report generation is time-consuming, and the analysis results often fail to indicate the specific category of the disease. As a result, blood-based disease screening suffers from low efficiency and poor accuracy.

To achieve the above objective, the present disclosure provides the following technical solutions:

In a first aspect, the present disclosure provides an RRAM-based blood test system, including:
a computing chip, an RRAM chip, a power supply module, and a sensor module, where the computing chip is connected to the RRAM chip; the RRAM chip is connected to the sensor module; and the power supply module is connected to the computing chip and the RRAM chip;
the sensor module is configured to test a substance in blood and convert test result data into a plurality of pieces of first voltage data;
the RRAM chip is configured to preprocess the received plurality of pieces of first voltage data and obtain second current data; and
the computing chip is configured to, based on the second current data, perform a function computation on the second current data according to a preset function computation model, and obtain a blood-based classification result, wherein the classification result is configured to represent a blood-based disease screening result.

In a second aspect, the present disclosure provides an RRAM-based blood test method, applied to the RRAM-based blood test system provided in the first aspect, and including:
acquiring the plurality of pieces of first voltage data sent by the sensor module;
preprocessing, based on the plurality of pieces of first voltage data, the plurality of pieces of first voltage data, and obtaining the second current data; and
performing, based on the second current data, the function computation on the second current data according to the preset function computation model, and obtaining the blood-based classification result, where the classification result is configured to represent the blood-based disease screening result.

Compared with the prior art, the RRAM-based blood test system provided in the present disclosure includes the computing chip, the RRAM chip, the power supply module, and the sensor module. The computing chip is connected to the RRAM chip, the RRAM chip is connected to the sensor module, and the power supply module is connected to the computing chip and the RRAM chip. The sensor module is configured to test the substance in the blood and convert the test result data into the plurality of pieces of first voltage data. The RRAM chip is configured to preprocess the received plurality of pieces of first voltage data and obtain second current data. The computing chip is configured to, based on the second current data, perform the function computation on the second current data according to the preset function computation model, and obtain the blood-based classification result, where the classification result is configured to represent the blood-based disease screening result. In this way, the present disclosure only requires a single tube of blood to quickly complete blood-based disease testing and output a classification result reflecting the severity of the disease, thereby improving the efficiency and accuracy of blood-based disease screening.

### BRIEF DESCRIPTION OF THE DRAWINGS

The drawings described herein are provided for further understanding of the present disclosure, and constitute a part of the present disclosure. The exemplary embodiments and illustrations of the present disclosure are intended to explain the present disclosure, but do not constitute inappropriate limitations to the present disclosure. In the drawings.

FIG. 1 is a system architecture diagram of a resistive random-access memory (RRAM)-based blood test system provided in the present disclosure;

FIG. 2 is a first schematic diagram of main components of the RRAM-based blood test system provided in the present disclosure;

FIG. 3 is a second schematic diagram of main components of the RRAM-based blood test system provided in the present disclosure;

FIG. 4 is a schematic diagram of an indium gallium zinc oxide (IGZO) sensor array of the RRAM-based blood test system provided in the present disclosure;

FIG. 5 is a schematic diagram of a 1-Transistor 1-Resistor (1T1R) memristor unit of the RRAM-based blood test system provided in the present disclosure; and

FIG. 6 is a flowchart of an RRAM-based blood test method provided in the present disclosure.

### DETAILED DESCRIPTION OF THE EMBODIMENTS

In the prior art, the blood-based disease screening exhibits significant limitations. For example, comprehensive disease screening often requires drawing multiple tubes of blood from a single patient to test for various proteins or enzymes. The medical analysis equipment is typically bulky and non-portable, restricting testing to fixed locations. Consequently, the blood test cannot derive a disease screening result quickly or determine the category of the disease. Therefore, currently, there is an urgent need to solve the technical problem of how to perform rapid disease screening and obtain a disease classification result only through a small amount of blood from a patient.

In view of this, the present disclosure provides a resistive random-access memory (RRAM)-based blood test system. The present disclosure only requires a small amount of blood from a patient, such as 10 mL of blood, to quickly screen for a basic disease shown in the blood sample and obtain a classification result of the basic disease, thereby improving the efficiency and accuracy of blood-based disease screening. The technical solution of the present disclosure is described below with reference to the drawings.

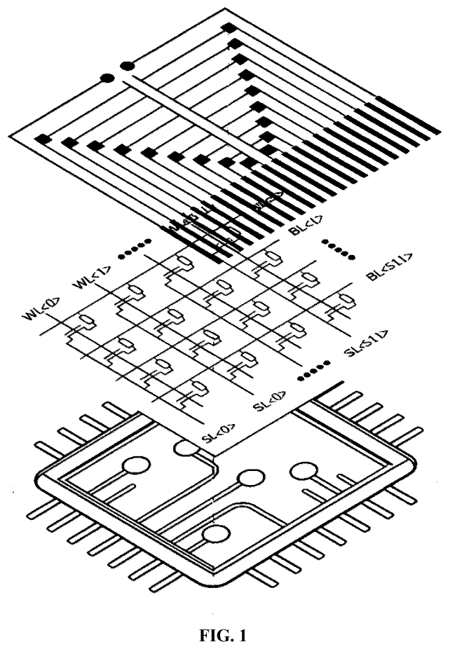

Please refer to FIG. 1. FIG. 1 is a system architecture diagram of the RRAM-based blood test system provided in the present disclosure.

In FIG. 1, the RRAM-based blood test system includes a three-layer integrated circuit structure, including a top layer serving as a sensor module layer, an intermediate layer serving as an RRAM chip-based analog computing-in-memory circuit, and a bottom layer serving as a computing chip circuit.

Since the blood test application scenario requires a large number of algorithm deployment weights, to save resources and reduce energy consumption, the embodiment of the present disclosure provides a memristor-based computing-in-memory circuit, which is a good solution for implementing analog computing-in-memory. The memristors implement a plurality of conductance state modulation on an RRAM device, corresponding to a plurality of weights in the matrix multiply-accumulate operation of a convolutional neural network (CNN). The weights programmed on the RRAM are used to perform data processing on the input data from the sensor module. Moreover, due to the non-volatility of the memristors, even if the memristors lose power, their preset weights will not disappear, and there is no need to reprogram and set the weights before the next logical inference, thereby greatly improving efficiency. Furthermore, the memristor-based computing-in-memory circuit has great advantages in reducing power consumption for implementing edge computing. Therefore, the proposed memristor-based computing-in-memory circuit can implement the computation and classification functions of the CNN. Using an indium gallium zinc oxide (IGZO) sensor array and a computing chip, an overall RRAM-based blood test circuit is completed for the CNN, which can achieve the technical effects of efficient blood-based disease screening and determination of severity of the disease.

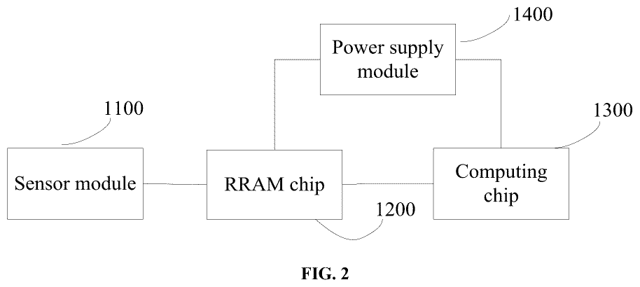

Furthermore, please refer to FIG. 2. FIG. 2 is a first schematic diagram of main components of the RRAM-based blood test system provided in the present disclosure.

In FIG. 2, the main components of the RRAM-based blood test system provided in the present disclosure are as follows.

The main components include a computing chip 1300, an RRAM chip 1200, a power supply module 1400, and a sensor module 1100. The computing chip 1300 is connected to the RRAM chip 1200. The RRAM chip 1200 is connected to the sensor module 1100. The power supply module 1400 is connected to the computing chip 1300 and the RRAM chip 1200.

The sensor module 1100 is configured to test a substance in blood and convert test result data into a plurality of pieces of first voltage data. The RRAM chip 1200 is configured to preprocess the received plurality of pieces of first voltage data and obtain second current data.

The computing chip 1300 is configured to, based on the second current data, perform a function computation on the second current data according to a preset function computation model, and obtain a blood-based classification result. The classification result is configured to represent a blood-based disease screening result.

It should be noted that the RRAM-based blood test system provided in the present disclosure is designed to perform early disease screening by testing a substance such as a protein or an enzyme in blood, and to determine the severity of a certain disease. Its main components may include an IGZO thin-film transistor (TFT) sensor array combined with an RRAM chip array and a computing chip. The IGZO TFT sensor array is configured to test the substance in blood. The blood is dropped into the IGZO TFT sensor array, and substance information in the blood is converted into an electrical signal. For example, a blood concentration is converted into an electrical signal. The RRAM chip array is configured to store neural network weights, and perform a computing-in-memory multiply-accumulate operation by a field programmable gate array (FPGA) logic control module. The computing chip is responsible for implementing an activation function, a pooling operation, and a softmax function required by an algorithm during inference. Regarding testing channels, they can be set according to requirements, that is, by configuring different numbers of computing chips 1300, RRAM chips 1200, and sensor modules 1100. In the embodiment of the present disclosure, the following settings are used as an example: 20 testing input channels (15 testing channels+5 blank controls), and 8 classification output channels/2 classification output channels. Two classification modes can be implemented. First, for early disease screening, a binary classification output is given to determine if there is a risk of suffering from several basic diseases. Second, for the severity of the disease, the severity of a certain disease is divided into eight levels, which can be accurately determined. The inference algorithm can be changed by changing the weight deployment of the RRAM chip array to switch the classification mode.

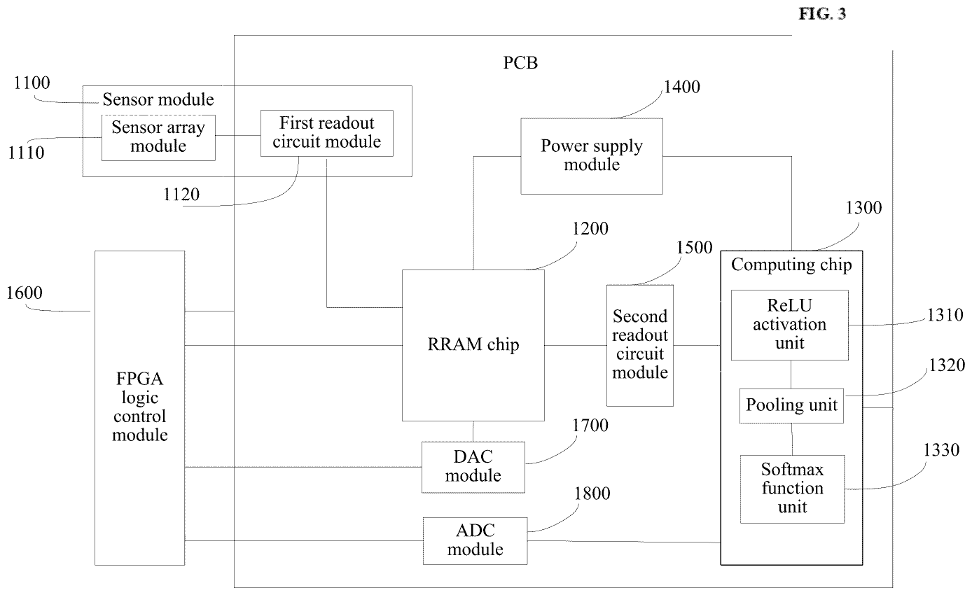

Preferably, please refer to FIG. 3. FIG. 3 is a second schematic diagram of main components of the RRAM-based blood test system provided in the present disclosure.

In FIG. 3, the computing chip 1300 includes: a pooling unit 1320 connected to a rectified linear unit (ReLU) activation unit 1310, and a softmax function unit 1330 connected to the pooling unit 1320.

The ReLU activation unit 1310 is configured to activate a mathematical function of a convolutional layer in a comprehensive computing module, such that a computing network model of the comprehensive computing module has a nonlinear capability. The pooling unit 1320 is configured to perform a pooling layer function, reducing a feature map size generated by the convolutional layer in the comprehensive computing module. The softmax function unit 1330 is configured to, based on output values of a preset number of output channels, perform a classification comparison, and take a channel corresponding to a maximum output value as a blood-based determination result.

Furthermore, the RRAM-based blood test system provided in the embodiment of the present disclosure further includes: an FPGA logic control module 1600, an analog-to-digital converter (ADC) module 1800, a digital-to-analog converter (DAC) module 1700, and a second readout circuit module 1500.

The FPGA logic control module 1600 is connected to the RRAM chip 1200. The second readout circuit module 1500 includes one end connected to the computing chip 1300 and another end connected to the RRAM chip 1200. The ADC module 1800 includes one end connected to the computing chip 1300 and another end connected to the FPGA logic control module 1600. The DAC module 1700 includes one end connected to the RRAM chip 1200 and another end connected to the FPGA logic control module 1600.

The FPGA logic control module 1600 is configured to perform an instruction control and a data transmission for the RRAM chip, the ADC module, and the DAC module that are connected to the FPGAlogic control module. The ADC module 1800 is configured to convert an input analog signal into a digital signal output. The DAC module 1700 is configured to convert an input digital signal into an analog signal output. The second readout circuit module 1500 is configured to read the second current data output by the RRAM chip 1200.

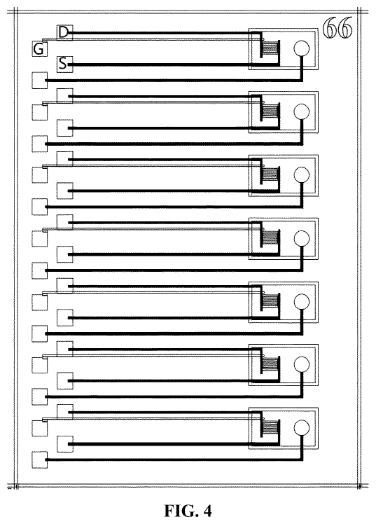

Specifically, please refer to FIG. 4. FIG. 4 is a schematic diagram of an IGZO sensor array structure of the RRAM-based blood test system provided in the present disclosure.

In FIG. 4, the IGZO sensor array performs a blood test and converts a substance concentration signal into an electrical signal. The IGZO TFT includes three ports: G, D, and S. The IGZO TFT can react with the protein or enzyme to generate a current. Therefore, the IGZO sensor array can convert the concentration of the protein or enzyme in the blood into a current signal.

Furthermore, an output current of the IGZO sensor array is processed by a first readout circuit module, including denoising and amplification by a transimpedance amplifier and a fully differential filter, thereby converting the current signal into a voltage signal. The transimpedance amplifier converts the output current signal from the IGZO into a voltage signal and stably inputs it into the RRAM chip array. The fully differential filter prevents noise aliasing caused by sampling during data conversion. The bandwidth can be limited to 30 kHz.

As an example, the sensor module 1100 described in the embodiment of the present disclosure includes an IGZO TFT sensor array module 1110 and a first readout circuit module 1120. The first readout circuit module 1120 includes one end connected to the IGZO TFT sensor array module 1110 and another end connected to the RRAM chip 1200.

The IGZO TFT sensor array module 1110 is configured to test the substance in the blood and obtain a plurality of pieces of current test data. The first readout circuit module 1120 is configured to read the plurality of pieces of current test data and convert the plurality of pieces of current test data into the plurality of pieces of first voltage data.

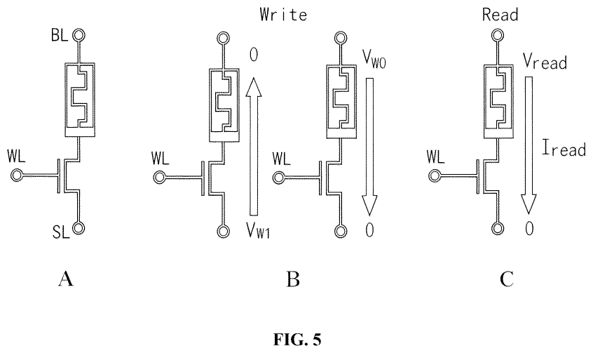

Furthermore, please refer to FIG. 5. FIG. 5 is a schematic diagram of a 1-Transistor 1-Resistor (1T1R) memristor unit of the RRAM-based blood test system provided in the present disclosure.

In FIG. 5, the input of the RRAM chip array is an analog voltage output by the first readout circuit module. Based on the principle of computing-in-memory of the RRAM chip, a matrix multiply-accumulate operation is performed to acquire an output cumulative current computation result.

For the memristor-based RRAM, classic operations include a read operation and a write operation. The write operation is further divided into a FORMING operation, a SET operation, and a RESET operation. The FORMING operation applies a one-time high voltage to form a conductive filament from scratch in a resistive switching layer, such that the memristor changes from an initial ultra-high resistance state (ultra-HRS) to a low resistance state (LRS). The SET operation applies a voltage pulse with the same polarity as the FORMING voltage to the memristor, with generally smaller voltage amplitude, to change the memristor from an HRS to an LRS. The RESET operation applies a voltage pulse with the opposite polarity to the FORMING operation to the memristor, breaking a formed conductive path, such that the device changes from the LRS back to the HRS. The read operation applies a read voltage smaller than a threshold voltage across the memristor, which does not change the resistance value of the memristor, but can read information in a specific memristor unit.

Analog resistive switching devices generally have a bidirectional continuous resistance switching capability. Whether it is a SET operation or a RESET operation, continuous adjustment of the memristor conductance state can be achieved. By using voltage pulses with equal amplitude for SET or RESET operations, the resistance switching process from the minimum conductance to the maximum conductance of the memristor or from the maximum conductance to the minimum conductance can be achieved, and the memristor can be modulated to a desired intermediate conductance state as needed.

If the CNN to be built is large in scale, since there are a large number of neurons, a large number of weight values need to be deployed. If only a single memristor is used for weight encoding, due to the interconnection between memristors, crosstalk will occur when modulating the conductance state of each memristor. This will affect the weight encoding of other memristors, thereby reducing the accuracy of function computation on blood test data. The use of the 1T1R memristor unit can avoid this problem and thus improve the accuracy of RRAM output data.

As shown in FIG. 5A, each memristor unit includes three ports, connected to a bit line (BL), a word line (WL), and a source line (SL) of the memristor array respectively. The programming voltage amplitude and continuous programming pulse time applied to a single memristor unit determine the operation of the corresponding memristor unit. As shown in FIG. 5B, the operating conditions for performing a write operation on the memristor unit are shown. During FORMING, the SL terminal of the transistor in the 1T1R structure is grounded, the BL is connected to a FORMING voltage, and the WL is connected to a high level to select the memristor unit. The method for the SET operation is similar to FORMING, except that the applied SET voltage amplitude is smaller. During RESET, the SL terminal of the transistor in the 1T1R structure is connected to a RESET voltage, the BL is grounded, and the WL is connected to a high level to select the memristor unit. The method for the read operation is shown in FIG. 5C. The read voltage Vread is connected to the BL, the SL is grounded, and the WL is connected to a high level to select the memristor unit. It can be seen that through this 1T1R structure, controlling the on and off of the memristor in the memristor array is very simple. By isolating the current paths between memristors, the conductance state of each memristor can be programmed without affecting other devices. The design can achieve more accurate current data output, thereby improving the accuracy of the entire blood test system for blood sample testing.

Furthermore, the computing chip 1300 includes three large modules: a ReLU activation unit 1310, a pooling unit 1320, and a softmax function unit 1330. The functions of each unit are introduced as follows.

The ReLU activation unit 1310 placed after the convolutional layer mainly uses a comparator to implement an activation function, thereby providing the network with a nonlinear capability. The ReLU function is chosen as the activation function because of the following considerations. The ReLU function can solve the problem of gradient vanishing in the positive interval. It has fast computation speed and simple discrimination, and its convergence speed is much faster than Sigmoid and Tanh. Therefore, it further improves the efficiency of analysis on the blood sample test data.

The main function of the pooling unit 1320 is to perform the pooling layer function, reducing the feature map size generated by the convolutional layer and reducing the amount of computation. Here, max pooling is performed, achieving a four-time pooling effect, which can reduce the computation amount by four times at once. The pooling module is connected after the ReLU activation module. It performs max pooling on the activated result, and the output result of the pooling is fed into the next network layer for computation.

The main function of the softmax function unit 1330 is to achieve the function of the softmax function and obtain the final classification output result. It should be noted that the number of classification channels for the softmax function can be set according to actual requirements, and it is not specifically limited in the present disclosure. In the embodiment of the present disclosure, the probability distribution output of the softmax function is replaced with a specific channel number output (0 to 7) merely as an example. Because the softmax function outputs the value with the maximum classification probability, it can directly compare which channel has the maximum value and output the corresponding channel number, achieving classification of eight disease conditions.

Based on this, the embodiment of the present disclosure provides a blood test circuit system capable of basic disease screening. This circuit system integrates sensing and computing, and can output the risk of suffering a basic disease and define the severity of the disease through computation and processing of substance concentration information in blood. By using an edge artificial intelligence (AI) computing chip, the circuit system reduces system power consumption. Meanwhile, the integrated design of sensing, information processing, and computing also improves the speed and security of the screening system, avoiding bulky medical analysis instruments that make the testing scenario fixed and inconvenient. Moreover, it avoids the need to draw a plurality of tubes of blood from a user during a physical examination to screen for a required protein or enzyme, and allows comprehensive disease screening with a small amount of blood. Therefore, the design improves the efficiency and accuracy of blood-based disease screening.

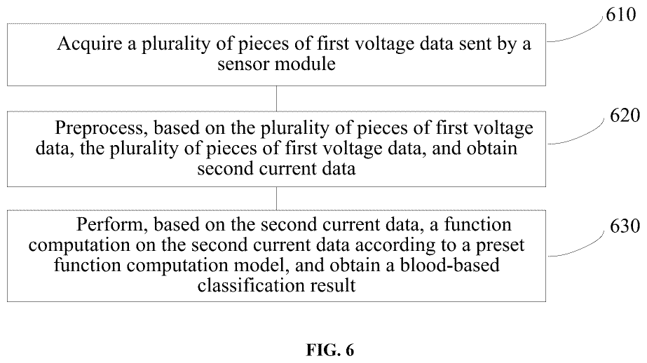

In a second aspect, based on the same technical concept as the first aspect, the embodiment of the present disclosure further provides an RRAM-based blood test method. The method is applied to the RRAM-based blood test system provided in the first aspect. Please refer to FIG. 6. FIG. 6 is a flowchart of the RRAM-based blood test method provided in the present disclosure.

As shown in FIG. 6, the method includes the following steps.

In step 610, the plurality of pieces of first voltage data sent by the sensor module are acquired.

In step 620, based on the plurality of pieces of first voltage data, preprocessing is performed on the plurality of pieces of first voltage data to acquire the second current data.

In step 630, based on the second current data, a function computation is performed on the second current data according to a preset function computation model to acquire a blood-based classification result. The classification result is configured to represent a blood-based disease screening result.

In the steps 610 to 630, the RRAM chip acquires the plurality of pieces of first voltage data sent by an upper sensor module, performs positive weighting and negative weighting on the plurality of pieces of first voltage data according to a preset neural network model in the RRAM chip, and performs data biasing to acquire the second current data. The second current data is input to a lower computing chip. The computing chip uses a preset function to perform a function computation on the second current data and obtain a blood-based screening classification result. Two classification modes can be achieved: early disease screening, and determination on the risk of suffering from several basic diseases and accurate determination on the severity of a certain basic disease.

Preferably, before the step 610, that is, before the plurality of pieces of first voltage data sent by the sensor module is acquired, the method may include the following steps. A substance in the blood is tested by the sensor module, and a plurality of pieces of current data are acquired. Preprocessing is performed on the plurality of pieces of current data, and the plurality of pieces of current data are converted into a plurality of pieces of voltage data. The plurality of pieces of voltage data is determined as the plurality of pieces of first voltage data. The preprocessing includes at least one of amplifying the plurality of pieces of current data by a transimpedance amplifier and denoising the plurality of pieces of current data by a fully differential filter. It should be noted that the transimpedance amplifier is essentially a current-to-voltage converter, which converts an input current into an output voltage through a feedback resistor, thereby achieving linear amplification of weak signals, and its output voltage is proportional to the input current. The essence of the fully differential filter is to suppress common-mode interference, improve linearity, and the output swing through its differential structure.

Specifically, amplification and denoising are performed through the transimpedance amplifier and the fully differential filter to convert the current signal into a voltage signal for output. For example, the output current signal from the IGZO sensor array is converted to a voltage signal through the transimpedance amplifier first, and then the voltage signal is denoised through the fully differential filter. This can prevent noise aliasing caused by sampling during data conversion, such that the output current signal from the IGZO sensor array is converted into a voltage signal and stably input into the RRAM chip array, thereby improving the accuracy of blood sample testing. The bandwidth during data processing is limited to 30 kHz.

Preferably, in the step 620, the preprocessing the plurality of pieces of first voltage data is as follows.

Based on a memristor conductance value of the RRAM, positive weighting is performed on the plurality of pieces of first voltage data, and first-column cumulative data is acquired. Negative weighting is performed on the plurality of pieces of first voltage data, and second-column cumulative data is acquired. Based on the first-column cumulative data and the second-column cumulative data, the second current data is acquired.

Furthermore, based on the first-column cumulative data and the second-column cumulative data, first differential data is acquired. Based on the first differential data, data biasing is performed on the first differential data according to a preset biasing strategy, and the second current data is acquired.

As an example, the voltage input signal to the memristor array can be encoded as an input vector for the CNN. The resistance value of the memristor, i.e., the conductance state, can be encoded as a weight value of a convolution kernel. The output current acquired by the memristor array represents the computation result of the convolution. By inputting the output current result into neurons, the computation process of forward inference of the neural network is completed. According to Ohm's law, when a voltage is applied to a conductance, acquiring the current value is equivalent to performing a multiplication operation. According to Kirchhoff's current law, the output current values from a plurality of rows converge, summing the currents flowing through individual devices, which is equivalent to performing an accumulate operation. Ultimately, the current values output from all rows collectively undergo a multiply-accumulate operation, yielding the result of the matrix-vector multiplication. The input voltage signal matrix (V₁, V₂, V₃, V₄) is multiplied by the memristor conductance value G set in the memristor array to acquire the output current signal (I₁, I₂, I₃, I₄), that is, a matrix multiplication operation is completed, and the computation result of matrix-vector multiplication is acquired. The memristor conductance value G includes a positive memristor conductance value and a negative memristor conductance value.

The computation result of matrix-vector multiplication is expressed as follows:

$${I}_{j} = {\sum }_{i = 1}^{4} {V}_{i} \cdot {G}_{ij} \qquad ( 1 )$$

where, i and j denote corresponding channels in the matrix, Vᵢ denotes the voltage signal matrix, and Gᵢⱼ denotes the corresponding memristor conductance value in the matrix.

The computational complexity of a conventional n-dimensional vector multiplied by an n×n matrix is O(n2), while the complexity of completing matrix-vector multiplication using a memristor array based on computing-in-memory is reduced to O(1), which can greatly reduce the resources and time consumed by the operation and accelerate the CNN.

The values in the weight matrix of a convolution kernel include positive values, negative values, and zero values, while the conductance values of memristors are non-negative. Therefore, usually two memristors are used to represent the weight of one convolution kernel. First, a convolution kernel of size 3×3 is converted into a one-dimensional column vector of size 9, and the values of its elements are mapped one by one to the memristor array, where every two memristors are used to represent a weight value of the convolution kernel. Then, the element values of the input image array are converted into voltage signals, that is, [X₁, X₂, . . . , X₉] denotes the pulse voltage values transmitted to the memristor array, and the input signals are transmitted from the horizontal lines to the array. Based on Ohm's law and Kirchhoff's law, the total current acquired on the vertical lines is proportional to the weighted input signal values flowing through the memristor array. Finally, the output data of the two columns of memristors are aggregated through a differential output circuit to acquire the final matrix-vector multiplication result.

The output data of the two columns of memristors are aggregated through the differential output circuit according to the following equation:

$${Y}_{1} = {R}_{b} {\sum }_{i = 1}^{9} ( {X}_{i} {g}_{i}^{+} - {X}_{i} {g}_{i}^{-} ) \qquad ( 2 )$$

where, gᵢ⁺ and gᵢ⁻ denote the memristor conductance values corresponding to an i-th pair of memristors, Xᵢ denotes the input voltage signal, Rb denotes the input resistance, and Y₁ denotes the output data acquired by aggregating the two columns of memristors through the differential output circuit.

The accumulated current is given to the computing chip for activation operation. After the ReLU function operation and the pooling operation are completed, the result is transmitted to the RRAM array for the same multiply-accumulate operation as in the above embodiment, to acquire the fully connected layer output of the RRAM, and the output result is input to the computing chip.

As an example, if the current values from the two columns are 20 (positive weight column) and 30 (negative weight column), with the bias set to 2, the result after the subtraction and bias addition is −8, and after passing through the ReLU function, the first output data becomes 0. If the current values from the two columns are 30 (positive weight column) and 20 (negative weight column), with the bias set to 2, the result after subtracting and adding bias is 12, and after passing through the ReLU function, the first output data becomes 12.

Furthermore, data processing is performed through the function computation model preset in the computing chip to acquire the classification result.

Preferably, in the step 630, the function computation performed on the second current data according to the preset function computation model is as follows. Based on the second current data, the function computation is performed through the ReLU activation unit according to the following equation:

$$ReLU ( x ) = Max ( 0 , x ) = \{ \begin{matrix}0 , & x < 0 \\ x , & x \geq 0\end{matrix} \qquad ( 3 )$$

where, x denotes an input value of the ReLU function, specifically first bias data, and ReLU(x) denotes first output data of the ReLU activation unit.

Furthermore, the function computation performed on the second current data according to the preset function computation model is as follows. Based on the first output data of the ReLU activation unit, max pooling is performed on the first output data of the ReLU activation unit through the pooling unit to acquire first pooling output data.

Specifically, the function computation performed on the second current data according to the preset function computation model further includes the following step. Based on the first pooling output data, data preprocessing is performed on the first pooling output data through the RRAM chip to acquire third output data. The method of performing data preprocessing on the first pooling output data through the RRAM chip is the same as the method of performing data preprocessing through the RRAM chip provided in the step 620 above, and is not repeated herein.

Based on the third output data, a computation is performed through the softmax function unit according to the following equation:

$$soft max ( i ) = \frac{{e}^{{η}_{i}}}{{\sum }_{j = 1}^{k} {e}^{{η}_{i}}} \qquad ( 4 )$$

where, e^{η}^{ᵢ} denotes an input value of an i-th channel; e^{η}^{ⱼ} denotes an input value of a j-th channel; k denotes a channel number; and softmax (i) denotes output data of the i-th channel output by the softmax function unit.

Furthermore, based on the output data of the i-th channel output by the softmax function unit, the values of the output data of each channel are compared, and a channel corresponding to the maximum value is taken as the blood-based classification result.

As an example, the probability distribution output of the softmax function can be replaced with a specific channel number output (0 to 7). Because the softmax function outputs the value with the maximum classification probability, the softmax function unit directly compares which channel has the maximum value and outputs the corresponding channel number. The softmax function unit can achieve eight-channel data classification. After the multiply-accumulate operation result of the fully connected layer is acquired, through a comparison computation, the value of the channel with the maximum classification probability is acquired as the final classification result. For example, if the first current is the largest, 0 is output, representing the lowest severity of the disease, and so on. If the eighth current is the largest, 7 is output, representing the highest severity of the disease.

Based on this, the RRAM-based blood test method proposed in the second aspect of the embodiment of the present disclosure is applied to the RRAM-based blood test system proposed in the first aspect to implement the following steps. A plurality of pieces of first voltage data sent by the sensor module is acquired. Based on the plurality of pieces of first voltage data, preprocessing is performed on the plurality of pieces of first voltage data, and second current data is acquired. Furthermore, based on the second current data, a function computation is performed on the second current data according to a preset function computation model to acquire a classification result for the collected blood. The classification result is configured to represent a blood-based disease screening result. In this way, the present disclosure achieves the blood test using integrated circuits and improves the efficiency and accuracy of blood-based disease screening.

Although the present disclosure has been described in combination with specific features and embodiments thereof, it is apparent that various modifications and combinations may be made without departing from the spirit and scope of the present disclosure. Correspondingly, the specification and drawings are merely exemplary descriptions of the present disclosure that are defined by the appended claims, and are deemed as covering any and all of the modifications, changes, combinations or equivalents within the scope of the present disclosure. It will be apparent to those skilled in the art that various modifications and variations can be made to the present disclosure without departing from the spirit and scope of the present disclosure. In this way, if these modifications and variations of the present disclosure fall within the scope of the claims of the present disclosure and equivalent technologies thereof, the present disclosure is further intended to include these modifications and variations.

What is claimed is:

1. A resistive random-access memory (RRAM)-based blood test system, comprising: a computing chip, an RRAM chip, a power supply module, and a sensor module, wherein
the computing chip is connected to the RRAM chip; the RRAM chip is connected to the sensor module; and the power supply module is connected to the computing chip and the RRAM chip;
the sensor module is configured to test a substance in blood and convert test result data into a plurality of pieces of first voltage data;
the RRAM chip is configured to preprocess the received plurality of pieces of first voltage data and obtain second current data; and
the computing chip is configured to, based on the second current data, perform a function computation on the second current data according to a preset function computation model, and obtain a blood-based classification result, wherein the classification result is configured to represent a blood-based disease screening result.

2. The system according to claim 1, wherein the computing chip comprises a rectified linear unit (ReLU) activation unit, a pooling unit, and a softmax function unit;
the ReLU activation unit is connected to the pooling unit; and the pooling unit is connected to the softmax function unit;
the ReLU activation unit is configured to activate a mathematical function of a convolutional layer in a comprehensive computing module, such that a computing network model of the comprehensive computing module has a nonlinear capability;
the pooling unit is configured to perform a pooling layer function, thereby reducing a feature map size generated by the convolutional layer in the comprehensive computing module; and
the softmax function unit is configured to, based on output values of a preset number of output channels, perform a classification comparison, and take a channel corresponding to a maximum output value as a blood-based determination result.

3. The system according to claim 1, wherein the sensor module comprises an indium gallium zinc oxide (IGZO) thin-film transistor (TFT) sensor array module and a first readout circuit module; and the first readout circuit module comprises one end connected to the IGZO TFT sensor array module and another end connected to the RRAM chip;
the IGZO TFT sensor array module is configured to test the substance in the blood and obtain a plurality of pieces of current test data; and
the first readout circuit module is configured to read the plurality of pieces of current test data and convert the plurality of pieces of current test data into the plurality of pieces of first voltage data.

4. The system according to claim 1, wherein the blood test system further comprises:
a field programmable gate array (FPGA) logic control module, an analog-to-digital converter (ADC) module, a digital-to-analog converter (DAC) module, and a second readout circuit module;
the FPGA logic control module is connected to the RRAM chip; the second readout circuit module comprises one end connected to the computing chip and another end connected to the RRAM chip; the ADC module comprises one end connected to the computing chip and another end connected to the FPGA logic control module; and the DAC module comprises one end connected to the RRAM chip and another end connected to the FPGA logic control module;
the FPGA logic control module is configured to perform an instruction control and a data transmission for the RRAM chip, the ADC module, and the DAC module that are connected to the FPGAlogic control module;
the ADC module is configured to convert an input analog signal into a digital signal output;
the DAC module is configured to convert an input digital signal into an analog signal output; and
the second readout circuit module is configured to read the second current data output by the RRAM chip.

5. The system according to claim 1, wherein the RRAM chip comprises memristor units; the memristor units are configured as 1-Transistor 1-Resistor (1T1R) memristor units; and each of the memristor units comprises three ports connected to a bit line (BL), a word line (WL), and a source line (SL) of a memristor array, respectively.

6. An RRAM-based blood test method, executed by a terminal or a server, wherein the terminal comprises a blood test device; the server is configured to control the blood test device; and the method comprises:
acquiring a plurality of pieces of first voltage data through a sensor module;
preprocessing the plurality of pieces of first voltage data, and obtaining second current data; and
performing, based on the second current data, a function computation on the second current data according to a preset function computation model, and obtaining a blood-based classification result, wherein the classification result is configured to represent a blood-based disease screening result.

7. The method according to claim 6, wherein before the acquiring a plurality of pieces of first voltage data through a sensor module, the method comprises: testing a substance in blood through the sensor module, and obtaining a plurality of pieces of current data; and
preprocessing the plurality of pieces of current data, converting the plurality of pieces of current data into a plurality of pieces of voltage data, and determining the plurality of pieces of voltage data as the plurality of pieces of first voltage data; and
the preprocessing the plurality of pieces of current data comprises:
amplifying the plurality of pieces of current data through a transimpedance amplifier, and denoising the plurality of pieces of current data through a fully differential filter.

8. The method according to claim 6, wherein the preprocessing the plurality of pieces of first voltage data comprises:
performing, based on a memristor conductance value of an RRAM, positive weighting on the plurality of pieces of first voltage data, and obtaining first-column cumulative data;
performing negative weighting on the plurality of pieces of first voltage data, and obtaining second-column cumulative data; and
acquiring, based on the first-column cumulative data and the second-column cumulative data, the second current data.

9. The method according to claim 8, wherein the acquiring, based on the first-column cumulative data and the second-column cumulative data, the second current data comprises:
acquiring, based on the first-column cumulative data and the second-column cumulative data, first differential data; and
biasing, based on the first differential data, the first differential data according to a preset biasing strategy, and obtaining the second current data; and
the performing a function computation on the second current data according to a preset function computation model comprises:
performing, based on the second current data, a computation through a ReLU activation unit as follows:
$$ReLU ( x ) = Max ( 0 , x ) = \{ \begin{matrix}0 , & x < 0 \\ x , & x \geq 0\end{matrix}$$
wherein, X denotes an input value of an ReLU function, specifically first bias data, and ReLU(X) denotes first output data of the ReLU activation unit.

10. The method according to claim 9, wherein the performing a function computation on the second current data according to a preset function computation model comprises:
performing, based on the first output data of the ReLU activation unit, max pooling on the first output data of the ReLU activation unit through a pooling unit, and obtaining first pooling output data.

11. The method according to claim 10, wherein the performing a function computation on the second current data according to a preset function computation model comprises:
preprocessing, based on the first pooling output data, the first pooling output data through an RRAM chip, and obtaining third output data; and
performing, based on the third output data, a computation through a softmax function unit as follows:
$$soft max ( i ) = \frac{{e}^{{η}_{i}}}{{\sum }_{j = 1}^{k} {e}^{{η}_{i}}}$$
wherein, e^{η}^{ᵢ} denotes an input value of an i-th channel; e^{η}^{ⱼ} denotes an input value of a j-th channel; k denotes a number of channels; and softmax (i) denotes output data of the i-th channel output by the softmax function unit.
